(19) United States
(12) Patent Application Publication
(10) Pub. No.: US 2011/0032424 A1
(43) Pub. Date: Feb. 10, 2011

(54) SYSTEMS AND METHODS FOR GRAPHICALLY ANNOTATING DISPLAYS PRODUCED IN A TELEVISION RECEIVER

(75) Inventors: Luke VanDuyn, Highlands Ranch, CO (US); Karen Taxier, Highlands Ranch, CO (US); Neil Marten, Denver, CO (US)

Correspondence Address: INGRASSIA FISHER & LORENZ, P.C. (EchoStar), 7010 E. COCHISE ROAD, SCOTTSDALE, AZ, 85253, US

(73) Assignee: ECHOSTAR TECHNOLOGIES LLC, Englewood, CO (US)

(21) Appl. No.: 12/535,471

(22) Filed: Aug. 4, 2009

(51) Int. Cl. H04N 5/44; H04N 7/173; G06F 3/048

(52) U.S. Cl. 348/553; 725/132; 715/773; 348/E05.1

(57) ABSTRACT

Systems, devices and methods provide for graphically annotating television images received and presented by a set top box (STB) or other television receiver. A pallette of available illustration tools is presented on the display in conjunction with the television image to be annotated, and the viewer is able to use the various illustration tools to make annotations, captions, edits or other changes to the displayed image. Viewer inputs may be provided via a touchpad, directional pad or other device capable of providing two-dimensional inputs.

### TECHNICAL FIELD

The present invention generally relates to user interfaces in television receiver devices, and more particularly relates to systems and methods for providing graphical editing and/or drawing of on-screen displays provided by a television receiver device.

### BACKGROUND

Most television viewers now receive their television signals through a content aggregator such as a cable or satellite television provider. For subscribers to a direct broadcast satellite (DBS) service, for example, television programming is received via a broadcast that is sent via a satellite to an antenna that is generally located on the exterior of a home or other structure. Other customers receive television programming through conventional television broadcasts, or through cable, wireless or other media. Programming is typically received at a receiver such as a “set top box” (STB) or other receiver that demodulates the received signals and converts the demodulated content into a format that can be presented to the viewer on a television or other display. In addition to receiving and demodulating television programming, many television receivers are able to provide additional features. Examples of features available in many modern television receivers include electronic program guides (EPGs), digital or other personal video recorders, “place-shifting” features for streaming received content over a network or other medium, providing customer service information and/or the like. These features are typically accessed and controlled using a graphical user interface that is generated by the STB or other receiver, and that responds to viewer instructions provided by a wireless remote control or other input device.

While conventional interfaces are useful for many purposes, there remains a continual desire for additional and unique features. Certain desirable features and characteristics of various embodiments will become apparent from the subsequent detailed description and the appended claims, taken in conjunction with the accompanying drawings and this background section.

### BRIEF SUMMARY

Systems, devices and methods are provided for graphically drawing on, editing or otherwise annotating an on-screen display produced by a set top box or other television receiver. By using an on-screen tool that allows the user to draw, highlight, erase, make captions and/or provide other edits to the displayed imagery, the user may be able to highlight interesting features of the display, to add fun or interesting captions, and/or to provide other benefits as desired. The annotated images may be presented on a display and/or shared with others in some embodiments.

Various embodiments provide a method executable within a television receiver for graphically modifying a television image produced on a display by the television receiver in response to viewer instructions transmitted from a remote control. The method comprises presenting the television image on the display in conjunction with a pallette, wherein the pallette comprises a plurality of illustration tools, and receiving a first two-dimensional input from the remote control that indicates one of the plurality of illustration tools presented within the pallette on the display. The indicated one of the plurality of illustration tools is selected in response to the first two-dimensional input. A second two-dimensional input from the remote control is also receiver, and the television image is annotated using the selected one of the plurality of illustration tools in response to the second two-dimensional input.

Other embodiments provide a method executable within a television receiver for providing an annotated image based upon television programming received at the television receiver in response to viewer instructions transmitted from a remote control. The method comprises receiving the television programming at the television receiver, decoding the television programming at the television receiver to obtain a television image for presentation on a display associated with the television receiver, presenting the television image on the display in conjunction with a pallette image that overlies the television image, wherein the pallette image indicates a plurality of available illustration tools, and annotating the television image by the television receiver using at least one of the available illustration tools in response to two-dimensional viewer inputs received via the remote control to thereby create the annotated image. The annotated image may be transmitted from the television receiver to a recipient via a communication network coupled to the television receiver.

Still other embodiments provide a video receiver for presenting imagery on a display in response to viewer input signals provided from a remote control. The video receiver comprises a receiver interface configured to receive an incoming modulated signal, a decoder configured to decode the incoming modulated signal to extract a video signal comprising a television image, a display interface configured to provide the video signal to the display, a wireless receiver configured to receive the viewer input signals from the remote control, wherein the viewer input is a two-dimensional input, and a controller. The controller is configured to receive the viewer input signals from the wireless receiver and to generate the imagery presented on the display, wherein the imagery comprises presenting the television image on the display in conjunction with a pallette image that overlies the television image, wherein the pallette image indicates a plurality of available illustration tools, and annotating the television image by the television receiver using at least one of the available illustration tools in response to two-dimensional viewer inputs received via the remote control to thereby create the annotated image.

Various other embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a block diagram of an exemplary television receiver system;

FIG. 2 is a block diagram of an exemplary television receiver device;

FIG. 3 is a flowchart showing an exemplary process for creating annotations on a television image; and

FIGS. 4 and 5 are diagrams of exemplary screen displays showing examples of annotations.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

Generally speaking, systems and methods are provided for graphically drawing on, editing and/or otherwise annotating an on-screen display produced by a set top box or other television receiver. The viewer is able to provide graphical drawings or other edits to imagery presented on a television receiver using two-dimensional or other user interface features. By using an on-screen tool that allows the user to draw, highlight, erase, make captions and/or provide other edits to the displayed imagery, for example, the user may be able to highlight interesting features of the display, to add fun or interesting captions, and/or to provide other benefits as desired. The annotated image may be shared with a friend or other recipient in some embodiments.

Although the various techniques and systems described herein may be used with any sort of remote control or command equipment, various embodiments may be particularly well suited for use with a remote control that includes a touchpad, directional pad, joystick, trackball, set of directional buttons, motion sensor and/or other feature capable of providing two-dimensional inputs to the receiver. Other embodiments may interact with a mouse, wand, nunchuk or other graphical input device that is plugged into or otherwise communicates with either the remote control and/or the television receiver itself.

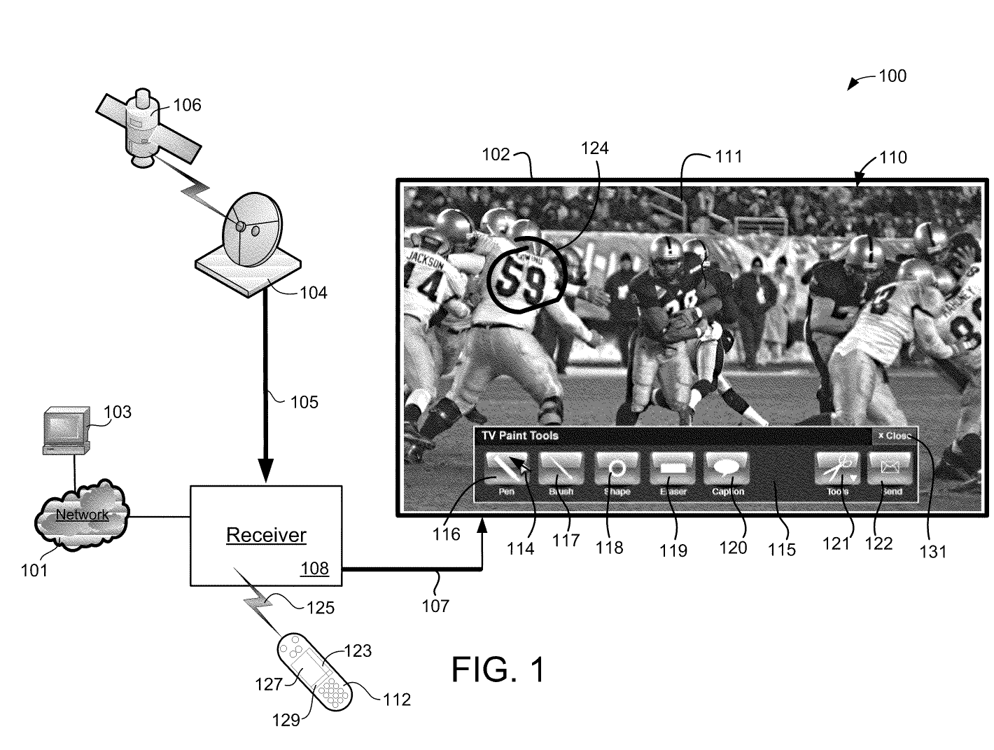

Turning now to the drawing figures and with initial reference to FIG. 1, an exemplary system 100 for presenting television signals to a viewer suitably includes a receiver 108 that receives signals 105 in any format and that generates appropriate outputs 107 to generate imagery 110 on display 102. Typically, receiver 108 interacts with signals 125 received from a wireless remote control 112 to present television imagery 110 on display 102 as desired by the viewer. Further, two-dimensional navigation features may be presented to allow the viewer to make annotations on the received imagery through control of a cursor 114 or other interface feature via remote control 112. In various embodiments, cursor 114 is able to move in response to two-dimensional input signals 125, which are, in turn, generated in response to inputs applied to two-dimensional input device 127. By moving cursor 114 to interact with the two-dimensional navigation features presented on display 102, television imagery can be changed, edited and/or otherwise annotated as desired.

In the exemplary view shown in FIG. 1, imagery 110 includes a television image 111 and a pallette 115 of tools 116-122 that can be used to annotate the television image 111 as desired. In the example shown in FIG. 1, pallette 115 is a graphical image on display 110 that includes icons representing a pen tool 116, a brush tool 117, a shape tool 118, an eraser tool 119, a caption tool 120, a “tools” feature 121 that allows access to even more tools, and a send tool 122. Other embodiments may use additional, fewer and/or different tools 116-122 as desired. Pallette 115 is also shown in FIG. 1 with a “close” button 131 that can be used to close or exit the annotation feature, as appropriate.

Imagery 110 is appropriately generated by receiver 108 based upon signals 105 received from a broadcast, DBS, cable or other source as supplemented with additional imagery as described herein. As shown in FIG. 1, the images of pallette 115 and tools 116-122 are generated by receiver 108 to overly the television imagery 111. Image 111 may be a moving image or a frozen “still” image that is obtained from a viewer depressing a “pause” button, or the like. Alternately, the image 111 to be annotated may be obtained from a DVR feature (e.g., a DVR implemented within receiver 108) or from any other source. Generally speaking, a viewer is allowed to make annotations of television image 111 using the structures and functions described herein.

In an exemplary embodiment, annotation tools are presented on pallette 115 for convenient selection by the viewer. Pallette 115 may be initially presented in response to any appropriate viewer input, such as a press of a button on remote control 112, or through activation of a menu-driven or other feature provided by receiver 108, or in any other manner. Each of the tools 116-122 provide one or more capabilities for annotating the image 111 in response to viewer inputs. To that end, the viewer typically selects one or more tools 116-122 by providing inputs to the remote control 112 (e.g., two-dimensional inputs using a touchpad, joystick or other multi-dimensional input device) that move cursor 114 to overly an icon associated with the desired tool 116-122. The tool may be selected through a conventional button press or other activation mechanism. The selected tool then processes subsequent inputs received from the viewer to create or modify the annotations on image 111. In the embodiment shown in FIG. 1, for example, television image 111 has an annotation 124 in which the viewer has encircled a number (“59”) on a football player's jersey. This circular annotation 124 may have been crudely drawn using pen tool 116 or brush tool 117, or drawn using a “shape” tool 118 as desired by the viewer. The types of annotations that may be created using the various tools 116-122 are limited only by the creativity of the viewer, and several other examples of annotations are described below.

The features presented in imagery 110 may vary widely from embodiment to embodiment. The various tool icons, for example, may vary in other embodiments and may not match the particular tools shown in FIG. 1. Moreover, the relative spacing, proportions, layouts, shapes and locations of the various windows, icons and other features described in the figure are entirely exemplary, and may vary widely in other embodiments. Other embodiments may similarly add or omit certain features, or may use the various features for purposes other than those described herein.

Receiver 108 is any component, device or logic capable of receiving and decoding video signals 105. In various embodiments, receiver 108 is a set-top box (STB) or the like capable of receiving satellite, cable, broadcast, streaming media and/or other signals 105 encoding audio/visual content. Receiver 108 may further demodulate or otherwise decode the received signals 105 to extract programming that can be locally viewed on display 102 as desired. Receiver 108 may also include a content database stored on a hard disk drive, memory, or other storage medium to support a digital or other personal video recorder (DVR/PVR) feature in some embodiments. Receiver 108 may also provide place shifting, electronic program guide, multi-stream viewing and/or other features as appropriate.

In the exemplary embodiment illustrated in FIG. 1, receiver 108 is shown receiving digital broadcast satellite (DBS) signals 105 from a satellite 106 at an antenna 104. Equivalent embodiments, however, could receive programming 105 from one or more programming sources, including any sort of satellite, cable or broadcast source, as well as any Internet or other network source or the like. In embodiments that include DVR functionality, programming may be stored in any sort of database as desired (e.g., in response to user/viewer programming instructions) for subsequent viewing. Content may also be received from digital versatile disks (DVDs), external DVR devices, or other media in some embodiments.

Display 102 is any device capable of presenting imagery 110 to a viewer. In various embodiments, display 102 is a conventional television set, such as any sort of television operating in accordance with any digital or analog protocols, standards or other formats. Display 102 may be a conventional NTSC, PAL and/or ATSC television receiver, for example. In other embodiments, display 102 is a monitor or other device that may not include built-in receiver functionality, but that is nevertheless capable of presenting imagery in response to signal 107 received from receiver 108. In various embodiments, receiver 108 and display 102 may be physically combined or interconnected in any manner. A receiver card, for example, could be inserted into a slot or other interface in a conventional television, or the functionality of receiver 108 may be provided within a conventional television display 102. In other embodiments, signals 107 are transferred between receiver 108 and display 102 using any sort of cable or other interface (including a wireless interface). Examples of common interfaces include, without limitation, component video, S-video, High-Definition Multimedia Interface (HDMI), Digital Visual Interface (DVI), IEEE 1394, and/or any other formats as desired.

Remote control 112 is any sort of control device capable providing signals 125 to receiver 108 that represent inputs received from one or more viewers. Typically, remote control 112 is an infrared, radio frequency (RF) or other wireless remote that includes any number of buttons or other features for receiving viewer inputs. In an exemplary embodiment, remote control 112 communicates with receiver 108 using the IEEE 802.15.4 (“ZIGBEE”) protocol for wireless personal area networks (WPANs), although other embodiments may instead communicate using IEEE 802.15.1 (“BLUETOOTH”), IEEE 802.11 (“WI-FI”), conventional infrared, and/or any other wireless techniques. In some embodiments, remote control 112 may be able to support multiple types of wireless communication, such as ZIGBEE communications and also infrared communications. This feature may be useful when remote control 112 is a so-called universal remote that is able to provide input signals 125 to multiple devices.

Remote control 112 generally includes any sort of buttons, sliders, rocker switches and/or other features for receiving physical inputs from the viewer. As the user depresses or otherwise interacts with the features, remote control 112 suitably produces wireless signals 125 in response. In further embodiments, remote control 112 includes a two-dimensional input device 127 that is able to receive inputs from the user in any multi-dimensional format (e.g, “X,Y”, “r,Θ”, and/or the like). Examples of two-dimensional input devices 127 that could be used in various embodiments include, without limitation, touchpads, directional pads, joysticks, trackballs, sets of arrows or other buttons, and/or the like. In a typical implementation, two-dimensional input device 127 provides coordinates or other signals 125 that indicate absolute (e.g, “X,Y”) and/or relative (e.g., “Δx,ΔY”) movement in two or more dimensions. Such signals 125 may be decoded at controller 108 or elsewhere to coordinate the viewer's actions with respect to input device 127 to movement of cursor 114 or other features presented on display 102.

In the exemplary embodiment shown in FIG. 1, remote control 112 is illustrated with a touchpad-type device 127 that accepts viewer inputs applied with a finger, stylus or other object. FIG. 1 also shows touchpad device 127 as having dedicated scroll regions 123 and 129 for vertical and horizontal scrolling, respectively. Viewer movements within region 123 that are more-or-less parallel to the right edge of device 127, for example, could result in vertical scrolling, whereas movements within region 128 that are more-or-less parallel to the bottom edge of device 127 could result in horizontal scrolling. Dedicated scrolling regions 123, 128 are optional features, however, that may not be present in all embodiments. Scrolling could be implemented in any other manner in other embodiments, including any manner that uses on-screen icons to produce scrolling or other navigation features as desired.

FIG. 1 also shows receiver 108 as communicating with any sort of recipient 103 via a network 101. To that end, network 101 is any sort of digital or other communications network capable of transmitting messages between senders and receivers. In various embodiments, network 101 includes any number of public or private data connections, links or networks supporting any number of communications protocols. Network 101 may include the Internet, for example, or any other network based upon TCP/IP or other conventional protocols. In various embodiments, network 101 may also incorporate a wireless and/or wired telephone network, such as a cellular communications network for communicating with mobile phones, personal digital assistants, and/or the like. Network 101 may also incorporate any sort of wireless or wired local area networks, such as one or more IEEE 802.3 and/or IEEE 802.11 networks. Receiver 108 may therefore be able to communicate with any number of recipients 103 in any manner. Such communication may take place over a wide area link that includes the Internet and/or a telephone network, for example; in other embodiments, communications between devices 108 and 103 may simply take place over a wired or wireless local area link incorporated within network 101.

Communications over network 101 may serve any appropriate purpose. Annotated images 111, for example, may be transmitted from receiver 108 to any sort of recipient 103 such as any sort of individual recipient (as identified by an email address, social media address, file transfer protocol site, IP address, telephone number or other identifier) or any sort of website or other service that is capable of sharing annotated images with other users. Other embodiments may omit network connectivity, or may provide additional or alternate communications features besides those described herein.

In operation, then, receiver 108 suitably receives television signals 105 from a satellite, cable, broadcast, media stream or other source. In a satellite based embodiment, for example, one or more channels can be extracted from a conventional satellite feed; the video content on the selected channel can be demodulated, extracted and otherwise processed as appropriate to display the desired content to the viewer. One or more cable or broadcast channels may be similarly obtained in any manner. In some embodiments, receiver 108 may obtain multiple channel signals from different sources (e.g., one channel from a cable or satellite source and another channel from a terrestrial broadcast, DVD or other source).

Receiver 108 suitably obtains the desired content from the channel(s) or other sources indicated by the viewer, and presents the content on display 102. In various embodiments, viewers are able to further view imagery (e.g., the imagery 110 shown in FIG. 1) and to make annotations (e.g., annotation 124 in FIG. 1) using one or more tools 116-122 that are available to the viewer. In the exemplary embodiment of FIG. 1, tools 116-122 are presented to the viewer using a pallette feature 115. By moving cursor 114 with respect to icons on pallette 115, for example, one or more tools 116-122 may be selected. A viewer may select the “pen” tool 116, for example, by directing cursor 114 toward the desired icon associated with the pen tool 116 in pallette 115, and then depressing a select or enter key on the remote 112 to select the indicated feature. The selected tool may be similarly manipulated or otherwise used in response to inputs received via the remote control to draw annotations on the television imagery 111 presented as part of display 110. The viewer may, for example, move cursor 114 using the two-dimensional input device 127 to draw lines, to place shapes, to select letters or numbers on a virtual keyboard, and/or to provide other inputs as appropriate to create the desired annotations 124.

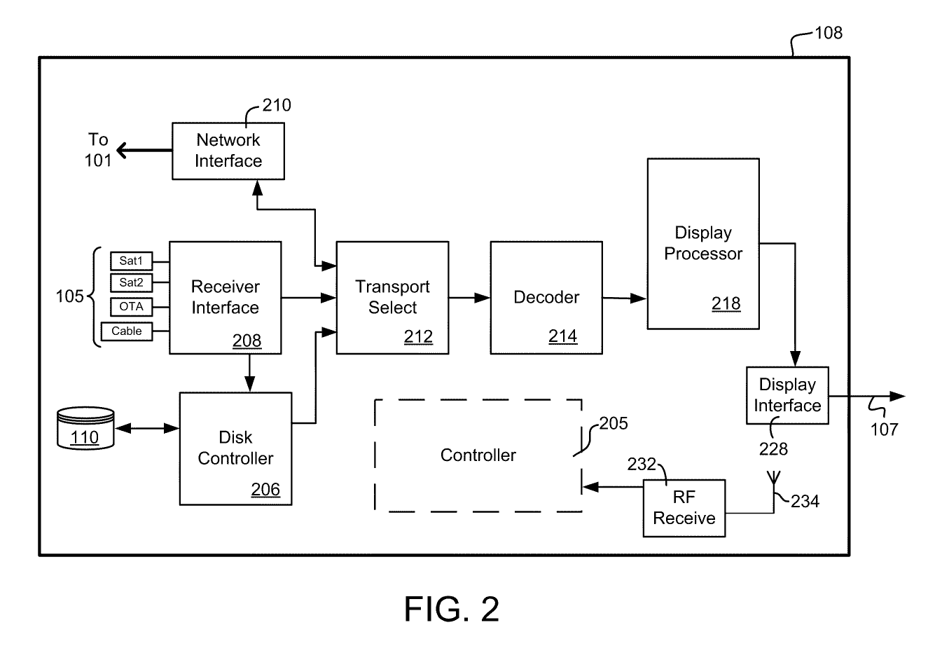

FIG. 2 provides additional detail about an exemplary receiver 108 that includes a receiver interface 208, a decoder 214 and a display processor 218, as appropriate. FIG. 2 also shows a disk controller interface 206 to a disk or other storage device 110, an interface 210 to a local or wide area network, a transport select module 212, a display interface 228, an RF receiver module and control logic 205. Other embodiments may incorporate additional or alternate processing modules from those shown in FIG. 2, may omit one or more modules shown in FIG. 2, and/or may differently organize the various modules in any other manner different from the exemplary arrangement shown in FIG. 2.

Receiver 108 may be physically and logically implemented in any manner. FIG. 2 shows various logical and functional features that may be present in an exemplary device; each module shown in the figure may be implemented with any sort of hardware, software, firmware and/or the like. Any of the various modules may be implemented with any sort of general or special purpose integrated circuitry, for example, such as any sort of microprocessor, microcontroller, digital signal processor, programmed array and/or the like. Any number of the modules shown in FIG. 2, for example, may be implemented as a “system on a chip” (SoC) using any suitable processing circuitry under control of any appropriate control logic 205. In various embodiments, control logic 205 executes within an integrated SoC or other processor that implements receiver interface 208, transport selector 212, decoder 214, display processor 218, disk controller 206 and/or other features, as appropriate. The Broadcom Corporation of Irvine, Calif., for example, produces several models of processors (e.g., the model BCM 7400 family of processors) that are capable of supporting SoC implementations of satellite and/or cable receiver systems, although products from any number of other suppliers could be equivalently used. In still other embodiments, various distinct chips, circuits or components may be inter-connected and inter-relate with each other to implement the receiving and decoding functions represented in FIG. 2.

Various embodiments of receiver 108 therefore include any number of appropriate modules for obtaining and processing media content as desired for the particular embodiment. Each of these modules may be implemented in any combination of hardware and/or software using logic executed within any number of semiconductor chips or other processing logic.

Various embodiments of control logic 205 can include any circuitry, components, hardware, software and/or firmware logic capable of controlling the various components of receiver 108. Various routines, methods and processes executed within receiver 108 are typically carried out under control of control logic 205, as described more fully below. Generally speaking, control logic 205 receives user input signals 125 (FIG. 1) via an RF or other receiver interface 232 that is able to communicate with the remote control 112 using a suitable antenna 234 or the like. Control logic receives user inputs from remote control 112 and/or any other source, and directs the other components of receiver 108 in response to the received inputs to present the desired imagery on display 102.

As noted above, receiver 108 suitably includes a receiver interface 208, which is any hardware, software, firmware and/or other logic capable of receiving media content via one or more content sources 105. In various embodiments, content sources 105 may include cable television, direct broadcast satellite (DBS), broadcast and/or other programming sources as appropriate. Receiver interface 208 appropriately selects a desired input source and provides the received content to an appropriate destination for further processing. In various embodiments, received programming may be provided in real-time (or near real-time) to a transport stream select module 212 or other component for immediate decoding and presentation to the user. Alternatively, receiver interface 208 may provide content received from any source to a disk or other storage medium in embodiments that provide DVR functionality. In such embodiments, receiver 108 may also include a disk controller module 206 that interacts with an internal or external hard disk, memory and/or other device that stores content in a database 110, as described above.

In the embodiment shown in FIG. 2, receiver 108 also includes an appropriate network interface 210, which operates using any implementation of protocols or other features to support communication by receiver 108 on any sort of local area, wide area, telephone and/or other network. In various embodiments, network interface 210 supports conventional LAN, WAN or other protocols (e.g., the TCP/IP or UDP/IP suite of protocols widely used on the Internet) to allow receiver 108 to communicate on the Internet or any other network as desired. Network interface 210 typically interfaces with the network using any sort of LAN adapter hardware, such as a conventional network interface card (NIC) or the like provided within receiver 108 that provides access to a conventional wired or wireless local area network. Other embodiments may provide interfaces 210 to conventional telephone lines or other communications channels, or may omit network connectivity altogether.

Transport stream select module 212 is any hardware and/or software logic capable of selecting a desired media stream from the available sources. In the embodiment shown in FIG. 2, stream select module 212 is able to generate video signals for presentation on one or more output interfaces 228. Typically, transport select module 212 responds to viewer inputs (e.g., via control logic 205) to simply switch encoded content received from a broadcast, satellite, cable or other source 105 or from storage 110 to one or more decoder modules 214.

Receiver 108 may include any number of decoder modules 214 for decoding, decompressing and/or otherwise processing received/stored content as desired. Generally speaking, decoder module 214 decompresses, decodes and/or otherwise processes received content from stream select module 212 to extract an MPEG or other media stream encoded within the stream. The decoded content can then be processed by one or more display processor modules 218 to create a presentation on display 102 (FIG. 1) for the viewer in any appropriate format. FIG. 2 shows a single decoder module 214 operating on one television signal received from transport select module 212. In practice, any number of decoder modules 214 may be used, particularly in “picture in picture” (PIP) situations when multiple signals are simultaneously decoded and displayed. The term “decoder”, then, may collectively apply to one or more decoder modules that are able to decode one or more signals for presentation on display 104.

Display processor module 218 includes any appropriate hardware, software and/or other logic to create desired screen displays via display interface 228 as desired. Such displays may include combining signals received from one or more decoder modules 214 to facilitate viewing of one or more channels. In various embodiments, display processing module 218 is also able to produce on screen displays (OSDs) for electronic program guide, setup and control, input/output facilitation and/or other features that may vary from embodiment to embodiment. Such displays are not typically contained within the received or stored broadcast stream, but are nevertheless useful to users in interacting with receiver 108 or the like. The generated displays, including received/stored content and any other displays may then be presented to one or more output interfaces 228 in any desired format. The various interface features described herein, for example, may be generated by display processor module 218 operating alone or in conjunction with control logic 205.

Display processor 218 may also generate imagery 11o in response to viewer inputs received (and/or in response to instructions from command logic 205) to thereby make up a user interface that allows the viewer select channels or programs, or to perform other tasks as desired. When the viewer provides inputs to select one or more drawing tools 116-122 on pallette 115 (FIG. 1), for example, display processor 218 may be operable to draw (or redraw) imagery 110 in response to create annotations on received imagery 111 as desired by the viewer. As receiver 108 receives user inputs 125 from remote control 112, control logic 205 may further direct display processor 218 to adjust any feature(s) of imagery 110 as directed by the viewer. Display processor 218 therefore directs the presentation of imagery 110 in conjunction with one or more navigation features, and adjusts the imagery 110 in response to inputs received from the viewer, including inputs that are used to create annotations on display 110.

Display processor 218 produces an output signal encoded in any standard format (e.g., ITU656 format for standard definition television signals or any format for high definition television signals) that can be readily converted to standard and/or high definition television signals at interface 228. In other embodiments, the functionality of display processor 218 and interface 228 may be combined in any manner.

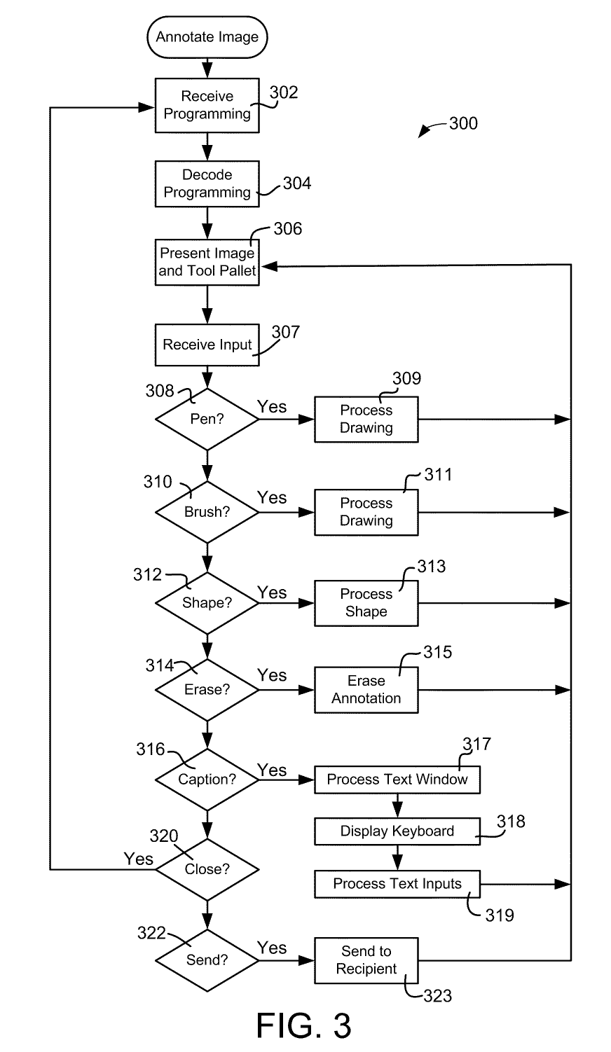

FIG. 3 shows an exemplary process 300 for graphically processing symbol-type inputs in a television receiver or the like. In various embodiments, the functions shown in FIG. 3 may be executed by any means using source or object code in any format that may be stored in mass storage, firmware, memory or any other digital storage medium within receiver 108. Such code may be executed by any module or combination of modules operating within receiver 108. In an exemplary embodiment, some or all of the functions shown in process 300 are executed by control logic 205 (FIG. 2) operating alone or in conjunction with a display processing module 218 and/or the various other features shown in FIG. 2 and described above. The various functions and actions set forth in FIG. 3 may be supplemented or otherwise modified in any manner.

With reference now to FIG. 3, an exemplary method 300 for processing numeric or other symbol-type data suitably includes the broad functions of presenting the television image on the display in conjunction with a pallette 115 that includes any number of illustration tools 116-122 (function 306), receiving a first two-dimensional input (function 307) that indicates one of the illustration tools 116-122 presented within the pallette on the display, selecting the indicated one of the illustration tools 116-122 in response to the first two-dimensional input (functions 308, 310, 312, 314, 316, 320, 322), and annotating the television image using the selected one of the plurality of illustration tools in response to subsequently-received two-dimensional inputs (functions 309, 311, 313, 315, 317-319). In some embodiments, the annotated image 111 may be sent to a recipient 103 via network 101 or the like (function 323). The functions of method 300 may take place in any other temporal order other than that shown in FIG. 3 and/or additional or alternate functions may be provided in alternate embodiments. The actual functions shown in FIG. 3 my be combined, supplemented and/or omitted in any number of other embodiments.

As shown in FIG. 3, receiver 108 suitably receives and decodes television programming as desired (functions 302, 304). As noted above, television programming signals 105 may be received from any number of DBS, cable, broadcast, streaming or other sources at one or more receiver interfaces 208. The received signals are selected (e.g., by transport selector 212) and decoded (e.g., by decoder 214) in response to viewer inputs received via the remote control 112 to provide extract television programming and other content that can be provided to display 102 using signals 107.

Imagery 110 is presented on display 102 in response to signals 107, as described above. This imagery may include any sort of still-frame or moving television image 111 that can be annotated in any manner. Viewers may indicate an interest in annotating an image in any manner. In various embodiments, a viewer indicates a desire to annotate an image by depressing an appropriate button on remote control 112 or selecting an annotation feature in a menu provided by receiver 108. In some embodiments, annotation features may be automatically enabled or accessed when a viewer pauses or freezes television viewing. That is, when a viewer activates a “pause” or similar feature, pallette 115 may be automatically presented, or an icon allowing the viewer to conveniently activate pallette 115 may be presented. Annotation features may be activated using any other techniques as well.

When annotation features are active, receiver 108 appropriately presents the television imagery 111 to be annotated in conjunction with a pallette 115 of available tools (function 306), as described herein. The appearance, location, size and tools provided by pallette 115 may vary widely from embodiment to embodiment. In an exemplary implementation, pallette 115 is a computer-generated image (produced, for example, by display processor 218) that overlies image 111 to allow convenient access to tools 116-122. Pallette 115 may be resizeable or moveable in some embodiments.

While the annotation feature is active, receiver 108 suitably processes inputs received from the remote control 112 to allow the viewer to select a desired annotation tool 116-122 (function 307). These inputs may be, for example, two dimensional inputs received from a touchpad, joystick, directional pad or other two-dimensional input device 127 associated with remote control 112. In an exemplary embodiment, the two-dimensional inputs guide cursor 114 around display 112 so that one or more icons presented on pallette 115 can be pointed and selected as desired.

Each of the various annotation tools 116-122 provide graphical or other features to facilitate the annotation or sharing of image 111. In the exemplary embodiment shown in FIG. 3, six functions corresponding to pen tool 116, brush tool 117, shape tool 118, erase tool 119, caption tool 120 and send tool 122 are described. Other equivalent embodiments may provide fewer tools, additional tools, and/or different tools from those described herein. Some embodiments may provide a line drawing, arrow drawing, and/or similar features, for example, in addition to those described herein. Like the tools 116-122 expressly described herein, any additional tools may be accessed using icons on pallette 115, through use an icon 121 (FIG. 1) that allows selection of additional tools, and/or using any other techniques.

If the viewer indicates a desire to use pen tool 116 (function 308), lines or other drawings can be provided on image 111 as desired (function 309). In various embodiments, pen tool 116 provides a cursor 114 or other indicator that identifies a location of a line to be drawing or a marking to be made using a pen-like interface feature. By providing subsequent two-dimensional inputs using input device 127, the indicator can be moved around image 111 to create lines and other markings as desired. Various embodiments may further allow the viewer to configure pen shape, pen size, virtual ink colors and/or any other parameters as desired.

If the viewer indicates a desire to use a brush tool 117 (function 310), brushed lines or other drawings can be made to image 111 as desired (function 311). Brush tool 117 may provide features similar to pen tool 116 in some embodiments, but with different drawing sizes, patterns or other features. In some embodiments, brush tool 117 may “paint” image 111 using a graphical pattern or other feature. By providing subsequent two-dimensional inputs using input device 127, cursor 114 or any other indicator can be moved around image 111 to create brushed lines, patterns or the like. Various embodiments may further allow the viewer to configure brush shape, size, pattern, color and/or any other parameters as desired.

If the viewer indicates a desire to use a shape tool 118 (function 312), polygons, circles and/or other shapes can be added to image 111 as desired (function 313). Shape tool 118 may be configurable to allow the viewer to selectively draw any number of different shapes (e.g., straight and/or curved lines, circles, squares, rectangles or other polygons) in some embodiments. By providing subsequent two-dimensional inputs using input device 127, cursor 114 or any other indicator can be moved around image 111 to allow positioning and/or sizing of selected shapes. Various embodiments may further allow the viewer to configure shape size, line thickness, fill patterns, and/or any other parameters as desired.

In some embodiments, the viewer is able to erase previously-drawing annotations using an eraser tool 119. If the viewer indicates a desire to use erase tool 119 (function 314), then lines, text or other drawings can be removed on image 111 as desired (function 315). By providing subsequent two-dimensional inputs using input device 127, the viewer is able to direct cursor 114 or any other indicator around image 111 to remove lines, patterns, text or other annotations that were previously created. By moving an eraser-shaped cursor 114 or the like around imagery 110, for example, any annotations that underlie the eraser icon can be removed. Various embodiments may further allow the viewer to configure eraser shape, size and/or any other parameters as desired.

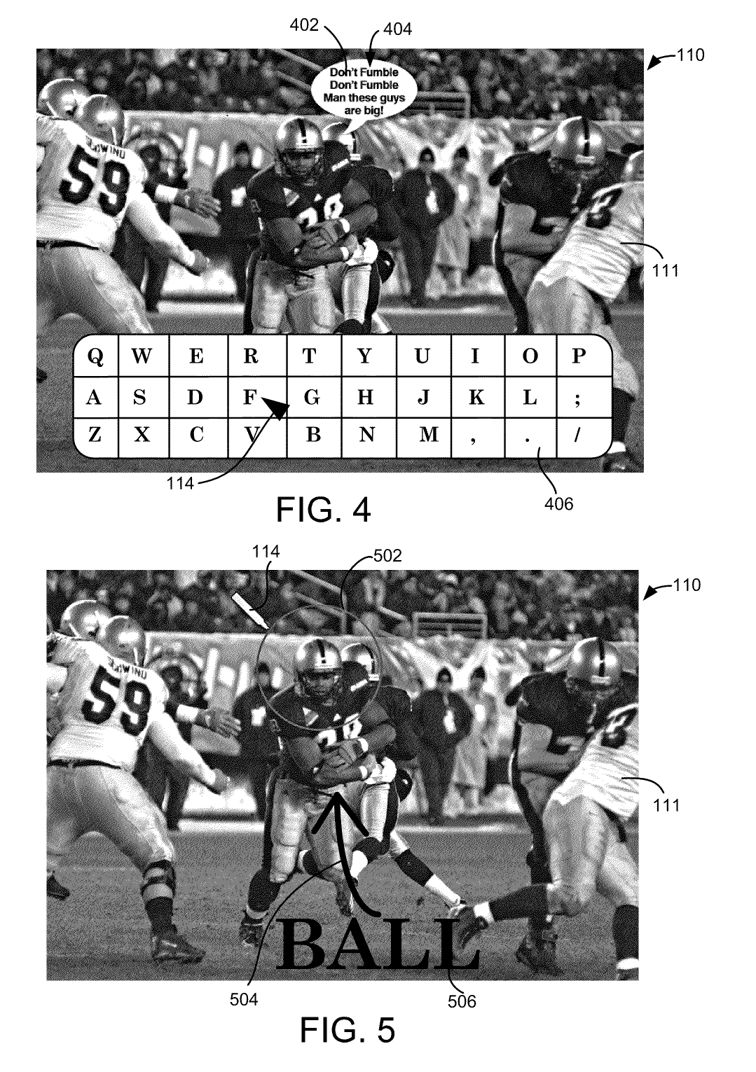

Some embodiments also provide the ability to annotate image 111 with textual comments. In the exemplary embodiment of FIG. 3, a caption tool 120 allows the viewer to enter alphanumeric captions on image 111 as desired. If the viewer selects the caption tool 120 (function 316), captions may be generated in any appropriate manner in response to subsequent inputs received from the viewer. In various embodiments, a text window is initially draw, selected and/or positioned (function 317) and textual data is entered into the text window as appropriate (function 319). In some implementations, text is entered using a virtual keyboard (function 318) or the like. An example embodiment showing a text caption annotation is described below with reference to FIG. 4. Other embodiments may allow further configuration of text windows and/or the text itself. Windows may be configured using different shapes, line widths, fill patterns and/or other formatting characteristics. Text presented within the caption may be formatted to select fonts, sizes, boldface, italics, underlines, left/right/center justification and/or any other features as desired.

Pallette 115 may be closed and/or annotation features may be deactivated using any appropriate techniques (function 320). In various embodiments, pallette 115 includes a “close” or “exit” window 131 (FIG. 1) that can be clicked, selected or otherwise manipulated to discontinue the annotation session. After the annotation session is closed, the annotated image may be stored (e.g., in database 110) for subsequent retrieval, viewing and/or editing. In other embodiments, the annotated image 111 is simply discarded in any appropriate manner.

Annotated images may be used for any appropriate purposes. In various embodiments, annotated images 111 are simply viewed on display 102 in a manner similer to a conventional teleprompter or other presentation tool. Such images may be used to highlight features discussed by a speaker or other viewer during a presentation or discussion, for example.

Annotated images may be stored in any conventional format that is presently known or subsequently developed. In various embodiments, images are stored as conventional .PNG, .TIFF, .JPG, .GIF, bitmap or other files. Images may be alternately stored in a portable document format (PDF) as desired. Many different image storage and transport formats are known, as are many different techniques for converting from MPEG or similar video programming to any of the image-based formats.

In some implementations, annotated images 111 may be transmitted to any recipient 103 via network 101 (function 323). As a viewer selects “send” tool 122 (function 322), for example, further dialog boxes or other interface features may be presented to allow the viewer to select an appropriate recipient for the annotated image. Recipients 103 may be other individuals (e.g., friends, family members, business acquaintances) that can receive image 111 via email, file transfer protocol, social media sites (e.g., FACEBOOK, TWITTER and/or similar services) or other network-based transport techniques as appropriate. Recipients 103 may alternately represent web sites (e.g., image hosting web sites) or other network-based servers that are capable of receiving and distributing annotated images in any format. To that end, images may be encapsulated in email, HTML, HTFP, FTP, MMS or any other transport formats for transmission on network 101.

FIGS. 4 and 5 show exemplary annotations that may be created using various embodiments. The various features shown in FIGS. 4 and 5 may be implemented using any sort of symbology, programming and/or the like; in an exemplary embodiment, imagery 110 is generated by display processing module 218 (FIG. 2) in response to instructions from the viewer that are relayed by control logic 205.

FIG. 4 shows an exemplary display 110 in which a television image 111 has been annotated with a caption 402 using, for example, caption tool 120 (FIG. 1). Caption 402 suitably includes alphanumeric text 404 that presents a humorous, informative or other message to the viewer. In various embodiments, the particular text 404 contained within the caption 402 may be entered by the viewer using a virtual keyboard 406 or the like. In one embodiment, the viewer creates caption 402 by initially selecting caption tool 120 on pallette 115 (FIG. 1), and then providing additional graphical or other inputs to position or draw the dialog window and enter text. Other embodiments may allow the viewer to select from any number of available dialog windows (e.g., windows of different shapes, sizes, colors, etc.), to re-size the dialog window (e.g., by selecting and dragging a corner or edge of the window), and to position or format text as desired. Text formatting may allow center, left or right justification, bold face, italics, underlining, or other formatting features as appropriate. In various embodiments, such features are made available using a menu or a toolbar feature, as desired.

In the exemplary embodiment of FIG. 4, a virtual keyboard 406 is presented that allows the viewer to enter text or other characters by using remote control 112. In this embodiment, the viewer uses the two-dimensional input 127 of the remote control 112 to position cursor 114 over virtual “keys” corresponding to desired letters, numbers, punctuation marks and/or other symbols. By selecting the keys on the virtual keyboard, text may be entered into the caption window or other interface feature as desired. In other embodiments, text may be entered using a conventional keyboard associated with receiver 108, or by using any other text entry techniques compatible with remote control 112 or any other input device. As an example of an alternate text entry technique, numeric keys may be associated with letters in some embodiments to allow “predictive text” or other text entry techniques similar to those commonly used to enter textual data on mobile phones.

FIG. 5 shows another type of annotation in which lines, shapes, text and/or other features may be combined or otherwise used to highlight a portion of the underlying television image 111. In the example of FIG. 5, a circle 502 is drawn around a player holding a ball to call attention to that particular player. Additionally, a textual caption (“BALL”) 506 and an arrow 504 has been drawing over the image 111 to call attention to the position of the ball in the image 111. Circle 502 may be drawn, for example, using shapes tool 118 (FIG. 1). Arrow 504 may be provided as an available shape in some embodiments. In other embodiments, arrow 504 may be manually drawn using pen tool 116, brush tool 117 or another feature (e.g., a line drawing tool) as desired. Text 506 may be entered using techniques similar to those described above, e.g., using a virtual keyboard or the like to enter text into a dialog window, balloon or other region of display 120. As shown in the example of FIG. 5, the various tools and techniques used herein may be inter-combined or otherwise used together to create any sort of annotations to image 111 that may be desired by the viewer. Other embodiments may provide additional or alternate features beyond those shown in FIGS. 4-5.

Accordingly, new systems and techniques are presented for graphically annotating television images received at a set top box or other television receiver. While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

As used herein, the word “exemplary” means “serving as but one example, instance, or illustration.” Any implementation described herein as “exemplary” is not necessarily to be construed as preferred or advantageous over any other implementations.

What is claimed is:

1. A method executable within a television receiver to graphically modify a television image produced on a display by the television receiver in response to viewer instructions transmitted from a remote control, the method comprising:
providing the television image to the display in conjunction with a pallette, wherein the pallette comprises a plurality of illustration tools;
receiving a first two-dimensional input from the remote control that indicates one of the plurality of illustration tools presented within the pallette on the display;
selecting the indicated one of the plurality of illustration tools in response to the first two-dimensional input;
receiving a second two-dimensional input from the remote control; and
annotating the television image using the selected one of the plurality of illustration tools and the second two-dimensional input.

2. The method of claim 1 wherein the annotating comprises generating an illustration using the selected one of the plurality of illustration tools that overlies the television image on the display to thereby create an illustrated television image.

3. The method of claim 2 further comprising transmitting the illustrated television image from the television receiver to a recipient over a communications network.

4. The method of claim 1 wherein the providing comprises providing the pallette overlying the television image on the display.

5. The method of claim 1 wherein the plurality of illustration tools comprises a drawing tool, and wherein the annotating comprises drawing a line over the television image that corresponds to the second two-dimensional input when the selected one of the plurality of illustration tools is the drawing tool.

6. The method of claim 5 wherein the drawing tool comprises a pen tool.

7. The method of claim 5 wherein the drawing tool comprises a brush tool.

8. The method of claim 1 wherein the plurality of illustration tools comprises a shape tool, and wherein the annotating comprises drawing a shape over the television image in response to the second two-dimensional input when the selected one of the plurality of illustration tools is the shape tool.

9. The method of claim 1 wherein the plurality of illustration tools comprises a caption tool, and wherein the annotating comprises drawing a dialog window over the television image that corresponds to the second two-dimensional input when the selected one of the plurality of illustration tools is the caption tool.

10. The method of claim 9 further comprising receiving subsequent viewer inputs from the remote control that correspond to textual data, and presenting the textual data in the dialog window.

11. The method of claim 10 further comprising generating a virtual keyboard on the display, and wherein the subsequent viewer inputs indicate portions of the virtual keyboard corresponding to the textual data.

12. The method of claim 1 wherein the plurality of illustration tools comprises an erase tool, and wherein the annotating comprises erasing previously-drawn illustrations in response to the second two-dimensional input when the selected one of the plurality of illustration tools is the erase tool.

13. The method of claim 12 wherein the remote control comprises a two-dimensional input device comprising one of the group consisting of: a touchpad, a trackball, a joystick, a directional pad and a motion sensor.

14. A method executable within a television receiver for providing an annotated image based upon television programming received at the television receiver in response to viewer instructions transmitted from a remote control, the method comprising:
receiving the television programming at the television receiver;
decoding the television programming using the television receiver to generate a television image for presentation on a display communicatively coupled to the television receiver;
providing the television image to the display in conjunction with a pallette image that overlies the television image, wherein the pallette image indicates a plurality of available illustration tools;
annotating the television image by the television receiver using at least one of the available illustration tools in response to two-dimensional viewer input signals received via the remote control to thereby create the annotated image; and
transmitting the annotated image from the television receiver to a recipient via a communication network coupled to the television receiver.

15. The method of claim 14 wherein the annotating comprises:
receiving a first two-dimensional input from the remote control that indicates one of the plurality of illustration tools presented within the pallette on the display;
selecting the indicated one of the plurality of illustration tools in response to the first two-dimensional input;
receiving a second two-dimensional input from the remote control; and
changing the television image using the selected one of the plurality of illustration tools in response to the second two-dimensional input.

16. A video receiver to present imagery on a display in response to viewer input signals provided from a remote control, the receiver comprising:
a receiver interface configured to receive an incoming modulated signal;
a decoder configured to decode the incoming modulated signal to extract a video signal comprising a television image;
a display interface configured to provide the video signal to the display;
a wireless receiver configured to receive the viewer input signals from the remote control, wherein the viewer input is a two-dimensional input; and
a controller configured to receive the viewer input signals from the wireless receiver and to generate the imagery presented on the display, wherein the imagery comprises the television image in conjunction with a pallette image that overlies the television image, wherein the pallette image comprises a plurality of available illustration tools, and wherein the controller is further configured to annotate the television image by the television receiver using at least one of the available illustration tools in response to the viewer input signals received via the remote control to thereby create the annotated image.

17. The video receiver of claim 16 further comprising a network interface to a communications network, and wherein the controller is further configured to transmit the annotated image from the television receiver to a recipient via a communication network coupled to the television receiver.

18. The video receiver of claim 16 wherein the receiver interface comprises at least one of the group consisting of a satellite interface, a broadcast television interface and a cable television interface.

19. The video receiver of claim 16 wherein the wireless receiver is configured to receive the viewer input signals from a wireless remote control comprising a two-dimensional input device.

20. The video receiver of claim 19 wherein the two-dimensional input device is one of the group consisting of: a touchpad, a trackball, a joystick, a directional pad, and a motion sensor.
